(19) United States
(12) Patent Application Publication
(10) Pub. No.: US 2020/0319934 A1
(43) Pub. Date: Oct. 8, 2020

(54) SYSTEM ARCHITECTURE AND METHODS OF EXPENDING COMPUTATIONAL RESOURCES

(71) Applicant: Purdue Research Foundation, West Lafayette, IN (US)

(72) Inventors: Tillmann C. Kubis, West Lafayette, IN (US); Xinchen Guo, West Lafayette, IN (US)

(73) Assignee: Purdue Research Foundation, West Lafayette, IN (US)

(21) Appl. No.: 16/835,330

(22) Filed: Mar. 31, 2020

Related U.S. Application Data
(60) Provisional application No. 62/830,112, filed on Apr. 5, 2019.

(51) Int. Cl. G06F 9/50; G06F 9/445

(52) U.S. Cl. CPC G06F 9/5055; G06F 9/44505

(57) ABSTRACT

Various embodiments of the present application relate to a resource management platform that monitors and controls the computational tasks dynamically, and improves or adapts the control during runtime. The resource management platform is able to enhance the resource usage; depending on the width of resource usage fluctuations of the original, unmanaged computational code, the performance enhancement can reach factors exceeding 3×.

### CROSS-REFERENCE TO RELATED APPLICATIONS

The present U.S. patent application is related to and claims the priority benefit of U.S. Provisional Patent Application Ser. No. 62/830,112, filed Apr. 5, 2019, the contents of which is hereby incorporated by reference in its entirety into this disclosure.

### BACKGROUND

This section introduces aspects that may help facilitate a better understanding of the disclosure. Accordingly, these statements are to be read in this light and are not to be understood as admissions about what is or is not prior art.

Most computational codes that solve research and development (R&D) problems require a lot of resources—either in terms of processing time, memory load or processing power. Only a small minority of these codes is optimized so thoroughly that—independent of the heterogeneous hardware—the available resources are fully used throughout the runtime. Incomplete usage of the available resources, however, means that a portion of the investment in the hardware is wasted, which can further delay computational time.

### SUMMARY

Various embodiments of the present application relate to a resource management platform that monitors and controls the computational tasks dynamically, and improves or adapts the control during runtime. The resource management platform is able to enhance the resource usage; depending on the width of resource usage fluctuations of the original, unmanaged computational code, the performance enhancement can reach factors exceeding 3×. Furthermore, the modifications on the existing computational tools are marginal. There is virtually no restriction in the nature of the computational tool to be compatible with our management platform.

One aspect of the present application relates to a non-transitory computer-readable medium encoded with a computer-readable program, which, when executed by a processor, will cause a computer to execute a method of expending computational resources, wherein the method includes benchmarking a computer resource usage of each secondary program of a plurality of secondary programs. The method further includes introducing a plurality of control points into the plurality of secondary programs, wherein each control point of the plurality of control points is configured to collect information about a respective secondary program status. The each secondary program includes a secondary program status, and wherein the each control point is configured to collect information about the secondary program status. The each control point of the plurality of control points is configured to send the respective secondary program status information to a primary program via an agent. And the each control point of the plurality of control points is configured to stop the respective secondary program.

Additionally, the method includes introducing a registration of a signal handler into each secondary program of the plurality of secondary programs. Next, the method includes initiating the agent. Further, the method includes initiating the primary program. The method also includes initiating the each secondary program of the plurality of secondary programs. The method moreover includes monitoring the each control points of the plurality of control points of the each secondary program via the agent. Thereafter, the method includes communicating the respective secondary program status information and/or a new data to the primary program via the agent, wherein the new data is produced by the each secondary program. Next, the method includes processing the respective secondary program status information and/or new data by the primary program according to a policy, thereby creating operating parameters for the each secondary program. The method also includes controlling the each secondary programs based on the operating parameters.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates a global view of the resource management platform.

FIG. 2 illustrates one example of a computing or processing node 1500 for operating a method or a software architecture in accordance with the present application.

### DETAILED DESCRIPTION

The following disclosure provides many different embodiments, or examples, for implementing different features of the present application. Specific examples of components and arrangements are described below to simplify the present disclosure. These are examples and are not intended to be limiting. The making and using of illustrative embodiments are discussed in detail below. It should be appreciated, however, that the disclosure provides many applicable concepts that can be embodied in a wide variety of specific contexts. In at least some embodiments, one or more embodiment(s) detailed herein and/or variations thereof are combinable with one or more embodiment(s) herein and/or variations thereof.

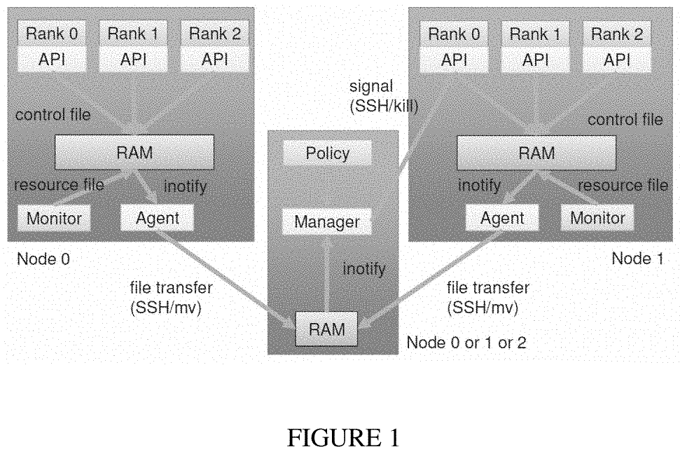

Example 1: FIG. 1 illustrates a global view of the resource management platform. A non-transitory computer-readable medium encoded with a computer-readable program, which, when executed by a processor, will cause a computer to execute a method of expending computational resources, wherein the method includes benchmarking a computer resource usage of each secondary program of a plurality of secondary programs. The method further includes introducing a plurality of control points into the plurality of secondary programs, wherein each control point of the plurality of control points is configured to collect information about a respective secondary program status. The each secondary program includes a secondary program status, and wherein the each control point is configured to collect information about the secondary program status. The each control point of the plurality of control points is configured to send the respective secondary program status information to a primary program via an agent. And the each control point of the plurality of control points is configured to stop the respective secondary program.

Additionally, the method includes introducing a registration of a signal handler into each secondary program of the plurality of secondary programs. Next, the method includes initiating the agent. Further, the method includes initiating the primary program. The method also includes initiating the each secondary program of the plurality of secondary programs. The method moreover includes monitoring the each control points of the plurality of control points of the each secondary program via the agent. Thereafter, the method includes communicating the respective secondary program status information and/or a new data to the primary program via the agent, wherein the new data is produced by the each secondary program. Next, the method includes processing the respective secondary program status information and/or new data by the primary program according to a policy, thereby creating operating parameters for the each secondary program. The method also includes controlling the each secondary programs based on the operating parameters.

In one or more embodiments, the agent is configured to monitor available resources on the computer.

In one or more embodiments, the introducing the plurality of control points into the plurality of secondary programs includes introducing the each control point before or after each hotspot of the each secondary program.

In one or more embodiments, the introducing the plurality of control points into the plurality of secondary programs includes introducing the each control point after the each secondary program has produced the new data.

In one or more embodiments, the introducing the registration of the signal handler into the each secondary program of the plurality of secondary programs includes introducing the registration of the signal handler into the each secondary program at a beginning of the each secondary program.

In one or more embodiments, the monitoring the each control points of the plurality of control points via the agent includes locating a command of the each secondary program executed by the computer, wherein the command is closest to a respective control point.

In one or more embodiments, the monitoring the each control points of the plurality of control points via the agent includes benchmarking currently used computer resources by the each secondary programs.

In one or more embodiments, the monitoring the each control points of the plurality of control points via the agent includes locating a command of the each secondary program executed by the computer, wherein the command is closest to a respective control point. The monitoring the each control points of the plurality of control points via the agent further includes benchmarking currently used computer resources by the each secondary programs.

In one or more embodiments, the communicating the respective secondary program status information and/or the new data to the primary program via the agent includes writing the respective secondary program status information and/or the new data into a file. The communicating the respective program status information and/or the new data into the primary program via the agent also includes notifying the agent about the file. Additionally, the communicating the respective program status information and/or the new data into the primary program via the agent also includes moving the file into a file system of the primary program. Moreover, communicating the respective program status information and/or the new data into the primary program via the agent also includes notifying the primary program about the file.

In one or more embodiments, the processing the respective secondary program status information by the primary program according to the policy includes translating the respective secondary program status information and/or the new data into the policy format. The processing the respective secondary program status information by the primary program according to the policy also includes processing the respecting secondary program status information and/or the new data according to at least one of internal status of the primary program, status information of the each secondary programs, or the new data of the each secondary programs. Next, the processing the respective secondary program status information by the primary program according to the policy includes creating operating parameters for the each secondary program.

In at least one embodiment, the processing the respecting secondary program status information and/or the new data according to the at least one of the internal status of the primary program, the status information of the each secondary programs, or the new data of the each secondary programs includes: scheduling a continuation of the each secondary program to achieve optimum computer resource usage based on the benchmarked computer resource usage of the each secondary program.

In at least one embodiment, the processing the respecting secondary program status information and/or the new data according to the at least one of the internal status of the primary program, the status information of the each secondary programs, or the new data of the each secondary programs includes: scheduling a continuation of the each secondary program to achieve earliest possible processing time of the new data.

In at least one embodiment, the processing the respecting secondary program status information and/or the new data according to the at least one of the internal status of the primary program, the status information of the each secondary programs, or the new data of the each secondary programs includes: scheduling a continuation of the each secondary program according to user input.

In at least one embodiment, the processing the respecting secondary program status information and/or the new data according to the at least one of the internal status of the primary program, the status information of the each secondary programs, or the new data of the each secondary programs includes: scheduling a continuation of the each secondary program to allow for additional secondary programs of the plurality of secondary programs being initialized.

In at least one embodiment, the processing the respecting secondary program status information and/or the new data according to the at least one of the internal status of the primary program, the status information of the each secondary programs, or the new data of the each secondary programs includes: scheduling a continuation to remove selected secondary programs of the plurality of secondary programs.

In at least one embodiment, the creating the operating parameters for the each secondary program includes: allocating computer resources to the each secondary program to ensure optimum usage of available computer resources.

In some embodiments, the controlling the each secondary programs based on the operating parameters includes: communicating to the each secondary program a kill signal, a continue signal, or a stop signal. Additionally, the controlling the each secondary programs based on the operating parameters includes communicating the allocated computer resources to the each secondary program by an operating system of the computer.

One of ordinary skilled in the art would recognize that the methodology described in the above example is programmed into a software architecture which is differentiated by various protocols, wherein each discretized protocol is configured to execute a different method.

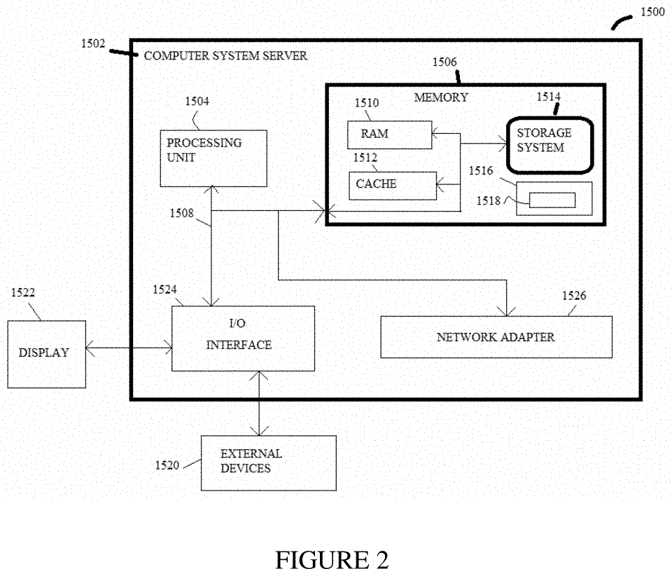

FIG. 2 illustrates one example of a computing or processing node 1500 for operating the methods and the software architecture of the present application. This is not intended to suggest any limitation as to the scope of use or functionality of embodiments of the invention described herein. Regardless, the computing node 1500 is capable of being implemented and/or performing any of the functionality set forth hereinabove.

In computing node 1500 there is a computer system/server 1502, which is operational with numerous other general purpose or special purpose computing system environments or configurations. Examples of well-known computing systems, environments, and/or configurations that may be suitable for use with computer system/server 1502 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1502 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1502 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 2, computer system/server 1502 in cloud computing node 1500 is shown in the form of a general-purpose computing device. The components of computer system/server 1502 may include, but are not limited to, one or more processors or processing units 1504, a system memory 1506, and a bus 1508 that couples various system components including system memory 1506 to processor 1504.

Bus 1508 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1502 typically includes a variety of computer system readable media. Such media may be any available media that is accessible by computer system/server 1502, and it includes both volatile and non-volatile media, removable and non-removable media.

System memory 1506, in one embodiment, implements the methods and the software architectures of the present application. The system memory 506 can include computer system readable media in the form of volatile memory, such as random access memory (RAM) 1510 and/or cache memory 1512. Computer system/server 1502 may further include other removable/non-removable, volatile/non-volatile computer system storage media. By way of example only, storage system 1514 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1508 by one or more data media interfaces. As will be further depicted and described below, memory 1506 may include at least one program product having a set (e.g., at least one) of program modules that are configured to carry out the functions of various embodiments of the invention.

Program/utility 1516, having a set (at least one) of program modules 1518, may be stored in memory 1506 by way of example, and not limitation, as well as an operating system, one or more application programs, other program modules, and program data. Each of the operating system, one or more application programs, other program modules, and program data or some combination thereof, may include an implementation of a networking environment. Program modules 1518 generally carry out the functions and/or methodologies of various embodiments of the invention as described herein.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Computer system/server 1502 may also communicate with one or more external devices 1520 such as a keyboard, a pointing device, a display 1522, etc.; one or more devices that enable a user to interact with computer system/server 1502; and/or any devices (e.g., network card, modem, etc.) that enable computer system/server 1502 to communicate with one or more other computing devices. Such communication can occur via I/O interfaces 1524. Still yet, computer system/server 1502 can communicate with one or more networks such as a local area network (LAN), a general wide area network (WAN), and/or a public network (e.g., the Internet) via network adapter 1526. As depicted, network adapter 1526 communicates with the other components of computer system/server 1502 via bus 1508. It should be understood that although not shown, other hardware and/or software components could be used in conjunction with computer system/server 1502. Examples, include, but are not limited to: microcode, device drivers, redundant processing units, external disk drive arrays, RAID systems, tape drives, and data archival storage systems, etc.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A non-transitory computer-readable medium encoded with a computer-readable program, which, when executed by a processor, will cause a computer to execute a method of executing programs efficiently, wherein the method comprises:
benchmarking a computer resource usage of each secondary program of a plurality of secondary programs;
introducing a plurality of control points into the plurality of secondary programs, wherein each control point of the plurality of control points is configured to collect information about a respective secondary program status, wherein the each secondary program comprises a secondary program status, and wherein the each control point is configured to collect information about the secondary program status, wherein the each control point of the plurality of control points is configured to send the respective secondary program status information to a primary program via an agent, wherein the each control point of the plurality of control points is configured to stop the respective secondary program;
introducing a registration of a signal handler into each secondary program of the plurality of secondary programs;
initiating the agent;
initiating the primary program;
initiating the each secondary program of the plurality of secondary programs;
monitoring the each control points of the plurality of control points of the each secondary program via the agent;
communicating the respective secondary program status information and/or a new data to the primary program via the agent, wherein the new data is produced by the each secondary program;
processing the respective secondary program status information and/or new data by the primary program according to a policy, thereby creating operating parameters for the each secondary program; and
controlling the each secondary programs based on the operating parameters.

2. The method of claim 1, wherein the agent is configured to monitor available resources on the computer.

3. The method of claim 1, wherein the introducing the plurality of control points into the plurality of secondary programs comprises:
introducing the each control point before or after each hotspot of the each secondary program.

4. The method of claim 1, wherein the introducing the plurality of control points into the plurality of secondary programs comprises:
introducing the each control point after the each secondary program has produced the new data.

5. The method of claim 1, wherein the introducing the registration of the signal handler into the each secondary program of the plurality of secondary programs comprises:
introducing the registration of the signal handler into the each secondary program at a beginning of the each secondary program.

6. The method of claim 1, wherein the monitoring the each control points of the plurality of control points via the agent comprises:
locating a command of the each secondary program executed by the computer, wherein the command is closest to a respective control point.

7. The method of claim 1, wherein the monitoring the each control points of the plurality of control points via the agent comprises:
benchmarking currently used computer resources by the each secondary programs.

8. The method of claim 1, wherein the monitoring the each control points of the plurality of control points via the agent comprises:
locating a command of the each secondary program executed by the computer, wherein the command is closest to a respective control point; and
benchmarking currently used computer resources by the each secondary programs.

9. The method of claim 1, wherein the communicating the respective secondary program status information and/or the new data to the primary program via the agent comprises:
writing the respective secondary program status information and/or the new data into a file;
notifying the agent about the file;
moving the file into a file system of the primary program; and
notifying the primary program about the file.

10. The method of claim 1, wherein the processing the respective secondary program status information by the primary program according to the policy comprises:
translating the respective secondary program status information and/or the new data into the policy format;
processing the respecting secondary program status information and/or the new data according to at least one of internal status of the primary program, status information of the each secondary programs, or the new data of the each secondary programs; and
creating operating parameters for the each secondary program.

11. The method of claim 10, wherein the processing the respecting secondary program status information and/or the new data according to the at least one of the internal status of the primary program, the status information of the each secondary programs, or the new data of the each secondary programs comprises:
scheduling a continuation of the each secondary program to achieve optimum computer resource usage based on the benchmarked computer resource usage of the each secondary program.

12. The method of claim 10, wherein the processing the respecting secondary program status information and/or the new data according to the at least one of the internal status of the primary program, the status information of the each secondary programs, or the new data of the each secondary programs comprises:
scheduling a continuation of the each secondary program to achieve earliest possible processing time of the new data.

13. The method of claim 10, wherein the processing the respecting secondary program status information and/or the new data according to the at least one of the internal status of the primary program, the status information of the each secondary programs, or the new data of the each secondary programs comprises:
scheduling a continuation of the each secondary program according to user input.

14. The method of claim 10, wherein the processing the respecting secondary program status information and/or the new data according to the at least one of the internal status of the primary program, the status information of the each secondary programs, or the new data of the each secondary programs comprises:
scheduling a continuation of the each secondary program to allow for additional secondary programs of the plurality of secondary programs being initialized.

15. The method of claim 10, wherein the processing the respecting secondary program status information and/or the new data according to the at least one of the internal status of the primary program, the status information of the each secondary programs, or the new data of the each secondary programs comprises:
scheduling a continuation to remove selected secondary programs of the plurality of secondary programs.

16. The method of claim 10, wherein the creating the operating parameters for the each secondary program comprises:
allocating computer resources to the each secondary program to ensure optimum usage of available computer resources.

17. The method of claim 16, wherein the controlling the each secondary programs based on the operating parameters comprises:
communicating to the each secondary program a kill signal, a continue signal, or a stop signal; and
communicating the allocated computer resources to the each secondary program by an operating system of the computer.
